(19) United States
(12) Patent Application Publication
(10) Pub. No.: US 2024/0013702 A1
(43) Pub. Date: Jan. 11, 2024

(54) DRIVING CIRCUIT AND DISPLAY DEVICE

(71) Applicant: TCL CHINA STAR OPTOELETRONIECS TECHNOLOGY CO., LTC., Shenzhen (CN)

(72) Inventors: Xinbo FU, Shenzhen (CN); Ruoqiao CHEN, Shenzhen (CN)

(73) Assignee: TCL CHINA STAR OPTOELETRONIECS TECHNOLOGY CO., LTC., Shenzhen (CN)

(21) Appl. No.: 17/435,724

(22) PCT Filed: Jun. 18, 2021
(86) PCT No.: PCT/CN2021/100788

§ 371 Date: Sep. 2, 2021

(30) Foreign Application Priority Data
Apr. 6, 2021 (CN) 202110622327.2

(51) Int. Cl. G09G 3/20

(52) U.S. Cl. CPC G09G 3/2096

(57) ABSTRACT

The present application discloses a driving circuit and a display device. The driving circuit includes a timing controller and a first voltage level converter. By using a first timing control signal and a second timing control signal outputted by the timing controller and incorporating timing logical relationship, the first voltage level converter generates a plurality of first clock signals.

### FIELD OF THE DISCLOSURE

The present application relates to display technologies, and more particularly to a driving circuit and a display device.

### DESCRIPTION OF RELATED ARTS

For a driving circuit of a display device, a Gate Driver on Array (GOA) technology is widely used. The GOA technology is a technology used to directly manufacture a gate drive circuit on an array substrate. This technology has advantages of narrow bezel, low cost and high product yield.

GOA driving needs a voltage level converter for amplifying a timing control signal outputted by a front-end timing controller to be with positive and negative voltages sufficient to turn on or off transistors in a GOA circuit so as to control the GOA circuit to be turned on stage by stage. However, in existing display devices, the timing controller outputs a large number of timing control signals, and a large trace wiring space is occupied accordingly. Also, it is resulted in a large number of occupied input/output (I/O) ports of the timing controller and a voltage level converter.

### SUMMARY

### Technical Problems

The present application provides a driving circuit and a display device, which can reduce the number of timing control signals outputted by a timing controller, thereby saving trace wiring space and reducing the number of occupied input/output (I/O) ports of the timing controller and a voltage level converter.

### Technical Solutions

In a first aspect, the present application provides a driving circuit, including:
a timing controller, configured to output a first timing control signal and a second timing control signal;
a first voltage level converter, connected to the timing controller, configured to output a first clock signal set based on the first timing control signal and the second timing control signal;

wherein the first clock signal set includes a plurality of first clock signals, the first voltage level converter determines a start time point of a rising edge of each of the first clock signals based on the first timing control signal, and the first voltage level converter determines the start time point of a falling edge of each of the first clock signals based on the second timing control signal.

In some embodiments of the present application, the start time point of a m-th rising edge of a n-th first clock signal corresponds to the start time point of a (n+(m−1)*k)-th rising edge of the first timing control signal, the start time point of a m-th falling edge of the n-th first clock signal corresponds to the start time point of a (n+(m−1)*k)-th rising edge of the second timing control signal, both n and m are integers greater than 0, and k is a number of the first clock signals.

In some embodiments of the present application, the first voltage level converter determines a pulse width of each of the first clock signals based on the start time point of the rising edge of the first timing control signal and the start time point of the falling edge of the second timing control signal.

In some embodiments of the present application, the pulse width of each of the first clock signals is equal to a difference between the start time point of a corresponding rising edge of the first timing control signal and the start time point of a corresponding falling edge of the second timing control signal.

In some embodiments of the present application, the first voltage level converter determines an edge cut-off width corresponding to the rising edge of the first clock signal based on a pulse width of the first timing control signal.

In some embodiments of the present application, the pulse width of the first timing control signal is equal to the edge cut-off width corresponding to the rising edge of the first clock signal.

In some embodiments of the present application, the first voltage level converter determines an edge cut-off width corresponding to the falling edge of the first clock signal based on a pulse width of the second timing control signal.

In some embodiments of the present application, the pulse width of the second timing control signal is equal to the edge cut-off width corresponding to the falling edge of the first clock signal.

In some embodiments of the present application, the timing controller is further configured to output a third timing control signal and a fourth timing control signal;

the driving circuit further includes a second voltage level converter, which is connected to the timing controller and is configured to output a second clock signal set based on the third timing control signal and the fourth timing control signal;

the second clock signal set includes a plurality of second clock signals, the second voltage level converter determines the start time point of the rising edge of each of the second clock signals based on the third timing control signal, and the second voltage level converter determines the start time point of the falling edge of each of the second clock signals based on the fourth timing control signal.

In some embodiments of the present application, the first timing control signal, the second timing control signal, the third timing control signal and the fourth timing control signal are signals having a same period and a predetermined phase difference.

In some embodiments of the present application, the first timing control signal and the third timing control signal are a same signal, and the second timing control signal and the fourth timing control signal are a same signal.

In some embodiments of the present application, the timing controller is further configured to output a third timing control signal and a fourth timing control signal;

the first voltage level converter is further configured to output a second clock signal set based on the third timing control signal and the fourth timing control signal;

the second clock signal set includes a plurality of second clock signals, the first voltage level converter determines the start time point of the rising edge of each of the second clock signals based on the third timing control signal, and the second voltage level converter determines the start time point of the falling edge of each of the second clock signals based on the fourth timing control signal.

In some embodiments of the present application, the timing controller is further configured to output a start control signal and a reset control signal;

the first voltage level converter is further configured to output a start signal based on the start control signal; the first voltage level converter is further configured to output a reset signal based on the reset control signal.

In some embodiments of the present application, the start time point of the rising edge of the first clock signal is equal to the start time point of a corresponding rising edge of the first timing control signal, and the start time point of the falling edge of the first control signal is equal to the start time point of a corresponding rising edge of the second timing control signal.

In a second aspect, the present application further provides a display device, including a display panel and a control panel connected to the display panel, the control panel including a driving circuit, which includes:
a timing controller, configured to output a first timing control signal and a second timing control signal;
a first voltage level converter, connected to the timing controller, configured to output a first clock signal set based on the first timing control signal and the second timing control signal;
wherein the first clock signal set includes a plurality of first clock signals, the first voltage level converter determines a start time point of a rising edge of each of the first clock signals based on the first timing control signal, and the first voltage level converter determines the start time point of a falling edge of each of the first clock signals based on the second timing control signal.

In some embodiments of the present application, the start time point of a m-th rising edge of a n-th first clock signal corresponds to the start time point of a (n+(m−1)*k)-th rising edge of the first timing control signal, the start time point of a m-th falling edge of the n-th first clock signal corresponds to the start time point of a (n+(m−1)*k)-th rising edge of the second timing control signal, both n and m are integers greater than 0, and k is a number of the first clock signals.

In some embodiments of the present application, the first voltage level converter determines a pulse width of each of the first clock signals based on the start time point of the rising edge of the first timing control signal and the start time point of the falling edge of the second timing control signal.

In some embodiments of the present application, the first voltage level converter determines an edge cut-off width corresponding to the rising edge of the first clock signal based on a pulse width of the first timing control signal.

In some embodiments of the present application, the first voltage level converter determines an edge cut-off width corresponding to the falling edge of the first clock signal based on a pulse width of the second timing control signal.

In some embodiments of the present application, the timing controller is further configured to output a third timing control signal and a fourth timing control signal;

the driving circuit further includes a second voltage level converter, which is connected to the timing controller and is configured to output a second clock signal set based on the third timing control signal and the fourth timing control signal;

the second clock signal set includes a plurality of second clock signals, the second voltage level converter determines the start time point of the rising edge of each of the second clock signals based on the third timing control signal, and the second voltage level converter determines the start time point of the falling edge of each of the second clock signals based on the fourth timing control signal.

### Beneficial Effects

In the driving circuit and the display device provided in the present application, by using the first timing control signal and the second timing control signal outputted by the timing controller and incorporating timing logical relationship, the first voltage level converter generates a plurality of first clock signals. Compared to the existing arts, the embodiment of the present application can generate a plurality of first clock signals by using a small number of timing control signals, thereby reducing the number of timing control signals outputted by the timing controller, saving trace wiring space, and reducing the number of occupied input/output (I/O) ports of the timing controller and the voltage level converter.

### DESCRIPTION OF DRAWINGS

For explaining the technical solutions used in the embodiments of the present application more clearly, the appended figures to be used in describing the embodiments will be briefly introduced in the following. Obviously, the appended figures described below are only some of the embodiments of the present application, and those of ordinary skill in the art can further obtain other figures according to these figures without making any inventive effort.

FIG. 1 is a schematic diagram showing a first structure of a driving circuit provided in an embodiment of the present application.

FIG. 2 is a timing diagram of the driving circuit shown in FIG. 1.

FIG. 3 is a schematic diagram showing a second structure of a driving circuit provided in an embodiment of the present application.

FIG. 4 is a timing diagram of the driving circuit shown in FIG. 3.

FIG. 5 is another timing diagram of the driving circuit shown in FIG. 3.

FIG. 6 is a schematic diagram showing a third structure of a driving circuit provided in an embodiment of the present application.

FIG. 7 is a schematic diagram showing the structure of a display device provided in an embodiment of the present application.

### DESCRIPTION OF EMBODIMENTS OF THE DISCLOSURE

The technical solutions in the embodiments of the present application are clearly and completely described below with reference to appending drawings of the embodiments of the present application. Obviously, the described embodiments are merely a part of embodiments of the present application and are not all of the embodiments. Based on the embodiments of the present application, all the other embodiments obtained by those of ordinary skill in the art without making any inventive effort are within the scope the present application.

It should be understood that the specific embodiments described herein are merely for illustrating and interpreting the present application and the present application is not limited thereto. In the specification and claims of the present application, the terms “first”, “second”, “third”, “fourth”, and so on are intended to distinguish between different objects rather than to indicate a specific order. In the specification and claims of the present application, the terms “include”, “include”, “have” and any other variants mean to cover the non-exclusive inclusion.

Embodiments of the present application provide a driving circuit and a display device, which will be described in detail below. It is noted that the order in describing the following embodiments is not intended to be treated as an order of preferred embodiments.

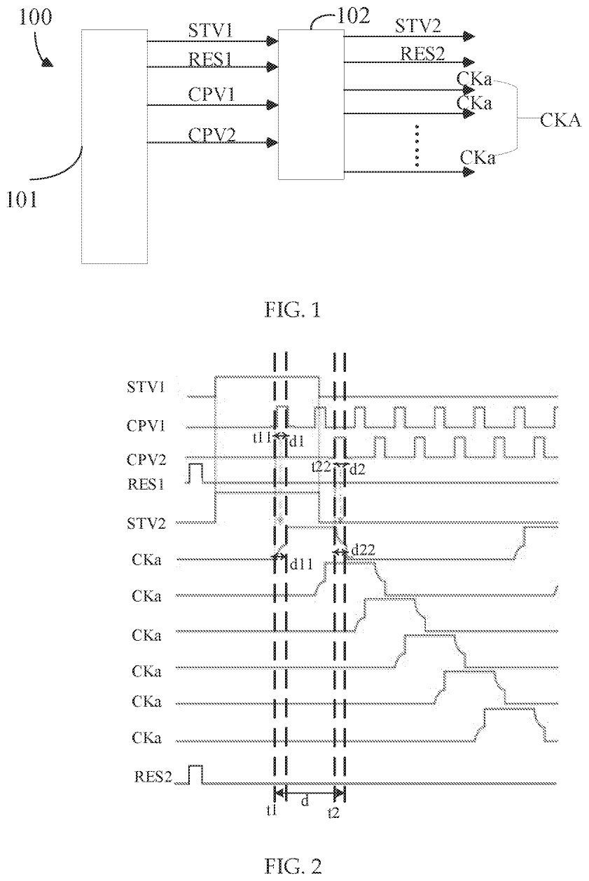

FIG. 1 is a schematic diagram illustrating a first structure of a driving circuit provided in an embodiment of the present application. The driving circuit 100 provided in the embodiment of the present application includes a timing controller 101 and a first voltage level converter 102. The timing controller 101 is connected to the first voltage level converter 102. The timing controller 101 is configured to output a first timing control signal CPV1 and a second timing control signal CPV2. The first voltage level converter 102 is configured to output a first clock signal set CKA based on the first timing control signal CPV1 and the second timing control signal CPV2. The first clock signal set CKA includes a plurality of first clock signals CKa. It needs to be noted that the number of the first clock signals CKa can be set based on actual needs.

In the embodiment of the present application, by using the first timing control signal CPV1 and the second timing control signal CPV2 outputted by the timing controller 101 and incorporating timing logical relationship, the first voltage level converter 102 generates a plurality of first clock signals CKa. The embodiment of the present application can generate a plurality of first clock signals CKa by using a small number of timing control signals, thereby reducing the number of timing control signals outputted by the timing controller 101, saving trace wiring space, and reducing the number of occupied input/output (I/O) ports of the timing controller 101 and the first voltage level converter 102.

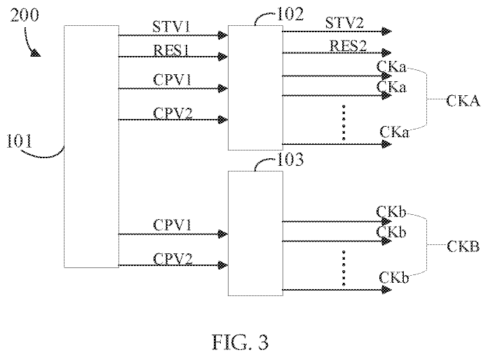

Specifically, please refer to FIG. 2, which is a timing diagram of the driving circuit shown in FIG. 1. As shown in FIG. 1 and FIG. 2, the first voltage level converter 102 determines the start time point t1 of the rising edge of each of the first clock signals CKa based on the first timing control signal CPV1. The first voltage level converter 102 determines the start time point t2 of the falling edge of each of the first clock signals CKa based on the second timing control signal CPV2.

It can be understood that since the first timing control signal CPV1 determines the start time point t1 of the rising edge of the first clock signal CKa and the second timing control signal CPV2 determines the start time point t2 of the falling edge of the first clock signal CKa, the embodiment of the present application can generate the plurality of first clock signals CKa by means of the timing logical relationship.

In an embodiment of the present application, the start time point t1 of the rising edge of the first clock signal CKa may be equal to the start time point t11 of a corresponding rising edge of the first timing control signal CPV1. The start time point t2 of the falling edge of the first clock signal CKa may be equal to the start time point t22 of a corresponding rising edge of the second timing control signal CPV2. Of course, in some embodiments, the start time point t1 of the rising edge of the first clock signal CKa may not be equal to the start time point t11 of a corresponding rising edge of the first timing control signal CPV1. The start time point t2 of the falling edge of the first clock signal CKa may not be equal to the start time point t22 of a corresponding rising edge of the second timing control signal CPV2. That is, the start time point t1 of the rising edge of the first clock signal CKa is approximately equal to the start time point t11 of a corresponding rising edge of the first timing control signal CPV1. The start time point t2 of the falling edge of the first clock signal CKa is approximately equal to the start time point t22 of a corresponding rising edge of the second timing control signal CPV2.

The start time point t1 of a m-th rising edge of a n-th first clock signal CKa corresponds to the start time point t11 of a (n+(m−1)*k)-th rising edge of the first timing control signal CPV1. The start time point t2 of a m-th falling edge of the n-th first clock signal CKa corresponds to the start time point t22 of a (n+(m−1)*k)-th rising edge of the second timing control signal CPV2. Both n and m are integers greater than 0, and k is the number of the first clock signals CKa. It needs to be noted that the correspondence mentioned here indicates that the start time point t1 of the m-th rising edge of the n-th first clock signal CKa is equal to or approximately equal to the start time point t11 of the (n+(m−1)*k)-th rising edge of the first timing control signal CPV1; the start time point t2 of the m-th falling edge of the n-th first clock signal CKa is equal to or approximately equal to the start time point t22 of the (n+(m−1)*k)-th rising edge of the second timing control signal CPV2.

For example, when n is equal to 1, m is equal to 1 and k is equal to 6, the start time point t1 of the first rising edge of the first first clock signal CKa corresponds to the start time point t11 of the first rising edge of the first timing control signal CPV1; the start time point t2 of the first falling edge of the first first clock signal CKa corresponds to the start time point t22 of the first rising edge of the second timing control signal CPV2. For another example, when n is equal to 1, m is equal to 2 and k is equal to 6, the start time point t1 of the second rising edge of the first first clock signal CKa corresponds to the start time point t11 of the seventh rising edge of the first timing control signal CPV1; the start time point t2 of the second falling edge of the first first clock signal CKa corresponds to the start time point t22 of the seventh rising edge of the second timing control signal CPV2.

The first voltage level converter 102 determines the pulse width d of each of the first clock signals CKa based on the start time point t11 of the rising edge of the first timing control signal CPV1 and the start time point t22 of the falling edge of the second timing control signal CPV2.

In an embodiment of the present application, the pulse width d of each of the first clock signals CKa may be equal to the difference between the start time point t11 of a corresponding rising edge of the first timing control signal CPV1 and the start time point t22 of a corresponding falling edge of the second timing control signal CPV2. Of course, in some embodiments, the pulse width d of each of the first clock signals CKa may not be equal to the difference between the start time point t11 of a corresponding rising edge of the first timing control signal CPV1 and the start time point t22 of a corresponding falling edge of the second timing control signal CPV2. That is, the pulse width d of each of the first clock signals CKa is approximately equal to the difference between the start time point t11 of a corresponding rising edge of the first timing control signal CPV1 and the start time point t22 of a corresponding falling edge of the second timing control signal CPV2.

The first voltage level converter 102 determines the edge cut-off width d11 corresponding to the rising edge of the first clock signal CKa based on the pulse width d1 of the first timing control signal CPV1. The first voltage level converter 102 determines the edge cut-off width d22 corresponding to the falling edge of the first clock signal CKa based on the pulse width d2 of the second timing control signal CPV2.

In an embodiment of the present application, the pulse width d1 of the first timing control signal CPV1 may be equal to the edge cut-off width d11 corresponding to the rising edge of the first clock signal CKa. Of course, in some embodiments, the pulse width d1 of the first timing control signal CPV1 may not be equal to the edge cut-off width d11 corresponding to the rising edge of the first clock signal CKa. That is, the pulse width d1 of the first timing control signal CPV1 is approximately equal to the edge cut-off width d11 corresponding to the rising edge of the first clock signal CKa.

In an embodiment of the present application, the pulse width d2 of the second timing control signal CPV2 may be equal to the edge cut-off width d22 corresponding to the falling edge of the first clock signal CKa. Of course, in some embodiments, the pulse width d2 of the second timing control signal CPV2 may not be equal to the edge cut-off width d22 corresponding to the falling edge of the first clock signal CKa. That is, the pulse width d2 of the second timing control signal CPV2 is approximately equal to the edge cut-off width d22 corresponding to the falling edge of the first clock signal CKa.

In some embodiments, the timing controller 101 is further configured to output a start control signal STV1 and a reset control signal RES1; the first voltage level converter 102 is further configured to output a start signal STV2 based on the start control signal STV1; the first voltage level converter 102 is further configured to output a reset signal RES2 based on the reset control signal RES1. The start control signal STV1 corresponds to the start signal STV2. The reset control signal RES1 corresponds to the reset signal RES2.

FIG. 3 is a schematic diagram illustrating a second structure of a driving circuit provided in an embodiment of the present application. The differences between the driving circuit 200 shown in FIG. 3 and the driving circuit 100 shown in FIG. 1 are that in the driving circuit 200 shown in FIG. 3, the timing controller 101 is further configured to output a third timing control signal CPV3 and a fourth timing control signal CPV4; the driving circuit 200 further includes a second voltage level converter 103, which is connected to the timing controller 101 and is configured to output a second clock signal set CKB based on the third timing control signal CPV3 and the fourth timing control signal CPV4. The second clock signal set CKB includes a plurality of second clock signals CKb. It needs to be noted that the number of the second clock signals CKb can be set based on actual needs.

In the embodiment of the present application, by using the first timing control signal CPV1 and the second timing control signal CPV2 outputted by the timing controller 101 by the first voltage level converter 102, using the third timing control signal CPV3 and the fourth timing control signal CPV4 outputted by the timing controller 101 by the second voltage level converter 103, and incorporating timing logical relationship, a plurality of first clock signals CKa and a plurality of second clock signals CKb are generated. The embodiment of the present application can generate a plurality of first clock signals CKa and a plurality of second clock signals CKb by using a small number of timing control signals, thereby reducing the number of timing control signals outputted by the timing controller 101, saving trace wiring space, and reducing the number of occupied input/output (I/O) ports of the timing controller 101, the first voltage level converter 102 and the second voltage level converter 103.

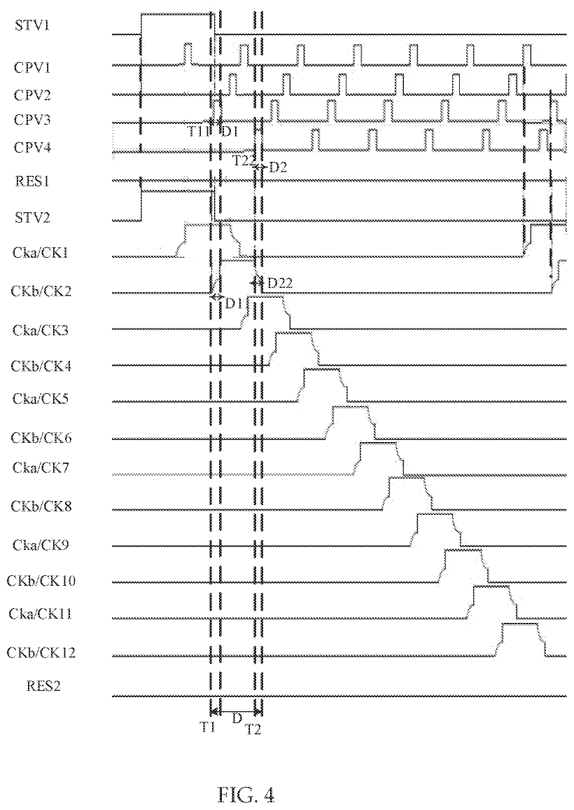

Specifically, please refer to FIG. 4, which is a timing diagram of the driving circuit shown in FIG. 3. As shown in FIG. 3 and FIG. 4, the second voltage level converter 103 determines the start time point T1 of the rising edge of each of the second clock signals CKb based on the third timing control signal CPV3. The second voltage level converter determines the start time point T2 of the falling edge of each of the first clock signals CKb based on the fourth timing control signal CPV4.

It can be understood that since the third timing control signal CPV3 determines the start time point T1 of the rising edge of the second clock signal CKb and the fourth timing control signal CPV4 determines the start time point T2 of the falling edge of the second clock signal CKb, the embodiment of the present application can generate the plurality of second clock signals CKb by means of the timing logical relationship.

In an embodiment of the present application, the start time point T1 of the rising edge of the second clock signal CKb may be equal to the start time point T11 of a corresponding rising edge of the third timing control signal CPV3. The start time point T2 of the falling edge of the second clock signal CKb may be equal to the start time point T22 of a corresponding rising edge of the fourth timing control signal CPV4. Of course, in some embodiments, the start time point T1 of the rising edge of the second clock signal CKb may not be equal to the start time point T11 of a corresponding rising edge of the third timing control signal CPV3. The start time point T2 of the falling edge of the second clock signal CKb may not be equal to the start time point T22 of a corresponding rising edge of the fourth timing control signal CPV4. That is, the start time point T1 of the rising edge of the second clock signal CKb is approximately equal to the start time point T11 of a corresponding rising edge of the third timing control signal CPV3. The start time point T2 of the falling edge of the second clock signal CKb is approximately equal to the start time point T22 of a corresponding rising edge of the fourth timing control signal CPV4.

The start time point T1 of a m-th rising edge of a n-th second clock signal CKb corresponds to the start time point T11 of a (n+(m−1)*k)-th rising edge of the third timing control signal CPV3. The start time point T2 of a m-th falling edge of the n-th second clock signal CKb corresponds to the start time point T22 of a (n+(m−1)*k)-th rising edge of the fourth timing control signal CPV4. Both n and m are integers greater than 0, and k is the number of the second clock signals. It needs to be noted that the correspondence mentioned here indicates that the start time point T1 of the m-th rising edge of the n-th second clock signal CKb is equal to or approximately equal to the start time point T11 of the (n+(m−1)*k)-th rising edge of the third timing control signal CPV3; the start time point T2 of the m-th falling edge of the n-th second clock signal CKb is equal to or approximately equal to the start time point T22 of the (n+(m−1)*k)-th rising edge of the fourth timing control signal CPV4.

The second voltage level converter 103 determines the pulse width D of each of the second clock signals CKb based on the start time point T11 of the rising edge of the third timing control signal CPV3 and the start time point T22 of the falling edge of the fourth timing control signal CPV4.

In an embodiment of the present application, the pulse width D of each of the second clock signals CKb may be equal to the difference between the start time point T11 of a corresponding rising edge of the third timing control signal CPV3 and the start time point T22 of a corresponding falling edge of the fourth timing control signal CPV4. Of course, in some embodiments, the pulse width D of each of the second clock signals CKb may not be equal to the difference between the start time point T11 of a corresponding rising edge of the third timing control signal CPV3 and the start time point of a corresponding falling edge of the fourth timing control signal CPV4. That is, the pulse width D of each of the second clock signals CKb is approximately equal to the difference between the start time point T11 of a corresponding rising edge of the third timing control signal CPV3 and the start time point of a corresponding falling edge of the fourth timing control signal CPV4.

The second voltage level converter 103 determines the edge cut-off width D11 corresponding to the rising edge of the second clock signal CKb based on the pulse width D1 of the third timing control signal CPV3. The second voltage level converter 103 determines the edge cut-off width D22 corresponding to the falling edge of the second clock signal CKb based on the pulse width D2 of the fourth timing control signal CPV4.

In an embodiment of the present application, the pulse width D1 of the third timing control signal CPV3 may be equal to the edge cut-off width D11 corresponding to the rising edge of the second clock signal CKb. Of course, in some embodiments, the pulse width D1 of the third timing control signal CPV3 may not be equal to the edge cut-off width D11 corresponding to the rising edge of the second clock signal CKb. That is, the pulse width D1 of the third timing control signal CPV3 is approximately equal to the edge cut-off width D11 corresponding to the rising edge of the second clock signal CKb.

In an embodiment of the present application, the pulse width D2 of the fourth timing control signal CPV4 may be equal to the edge cut-off width D22 corresponding to the falling edge of the second clock signal CKb. Of course, in some embodiments, the pulse width D2 of the fourth timing control signal CPV4 may not be equal to the edge cut-off width D22 corresponding to the falling edge of the second clock signal CKb. That is, the pulse width D2 of the fourth timing control signal CPV4 is approximately equal to the edge cut-off width D22 corresponding to the falling edge of the second clock signal CKb.

In an embodiment of the present application, the first timing control signal CPV1, the second timing control signal CPV2, the third timing control signal CPV3 and the fourth timing control signal CPV4 are signals having a same period and a predetermined phase difference. In practical applications, for a display device with 8K or 4K resolution and a refresh rate of 120 Hz, a GOA circuit needs 12 clock signals CK1 to CK12. The plurality of first clock signals CKa are CK1, CK3, CK5, CK7, CK9, and CK11 in order. The plurality of second clock signals CKbs are CK2, CK3, CK6, CK8, CK10, and CK12 in order.

FIG. 5 is another timing diagram of the driving circuit shown in FIG. 3. In some embodiments, the first timing control signal CPV1 and the third timing control signal CPV3 are a same signal, and the second timing control signal CPV2 and the fourth timing control signal CPV4 are a same signal. In practical applications, for a display device with 8K or 2K resolution and a refresh rate of 220 Hz, a GOA circuit needs 12 clock signals CK1 to CK12. The plurality of first clock signals CKa are CK1, CK3, CK5, CK7, CK9, and CK11. The plurality of second clock signals are CK2, CK3, CK6, CK8, CK10, and CK12.

Specifically, the timing controller 101 is configured with four timing control signal output ends, and each of the first voltage level converter 102 and the second voltage level converter 103 is configured with two timing control signal output ends and six clock signal output ends. This improves the utilization of I/O ports of the timing controller 101, the first voltage level converter 102 and the second voltage level converter 103, reduces the number of signal lines, saves trace wiring space, and effectively controls the size of cost of an individual voltage level converter.

In addition, the driving circuit 200 provided in the embodiment of the present application places the driving of the first clock signals CK1, CK3, CK5, CK7, CK9, and CK11 in the first voltage level converter 102 and places the driving of the second clock signals CK2, CK3, CK6, CK8, CK10, and CK12 in the second voltage level converter 103. This disperses the power consumption of the voltage level converters, and it is beneficial for improving a rise of temperature of the voltage level converters. Further, by controlling the pulse width of the first timing control signal CPV1, the second timing control signal CPV2, the third timing control signal CPV3 and the fourth timing control signal CPV4, an edge cut-off function can be realized for the clock signals, and the control is simple.

It should be noted that in the existing arts, one timing controller 101 needs to output 12 timing control signals to one voltage level converter, and the one voltage level converter generates 12 clock signals based on the 12 timing control signals in one-to-one correspondence. In a first aspect, the plurality of timing control signals occupy a larger trace wiring space, and the number of occupied I/O ports of the timing controller 101 and the voltage level converter is large. In addition, the timing of each timing control signal needs to be adjusted separately, the adjustment is complicated, and it takes a lot of time. In a second aspect, the power consumption of an individual voltage level converter is high as well as the temperature. In a display device with 8K or 4K resolution and a refresh rate of 120 Hz, the panel size is large, the number of rows of scan lines is large, and overall impedance will significantly increase. Using a single voltage level converter to drive at a single side will have a heavy high-level/low-level current load. In addition, since it is very short for each row scan (about 1.85 us for 1H), the frequency of voltage level switching in the GOA driving is much higher, and the possibility of damage of a built-in switch device of the voltage level converter increases. It is easy to cause a rise of temperature when steady-state power consumption and transient-state loss of the voltage level converter increases. In a third aspect, no control is available for cut-off edge of the timing control signals, and it is uncontrollable for the timing control signals to be switched between high and low levels in transient state. This causes the clock signals to have a large current, and it is not beneficial for improving the temperature and power consumption drawbacks.

Conversely, the embodiment of the present application improves the utilization of I/O ports of the timing controller 101, the first voltage level converter 102 and the second voltage level converter 103, reduces the number of signal lines, saves trace wiring space, and effectively controls the size of cost of an individual voltage level converter. This disperses the power consumption of the voltage level converters, and it is beneficial for improving a rise of temperature of the voltage level converters. Further, by controlling the pulse width of the first timing control signal CPV1, the second timing control signal CPV2, the third timing control signal CPV3 and the fourth timing control signal CPV4, an edge cut-off function can be realized for the clock signals, and the control is simple.

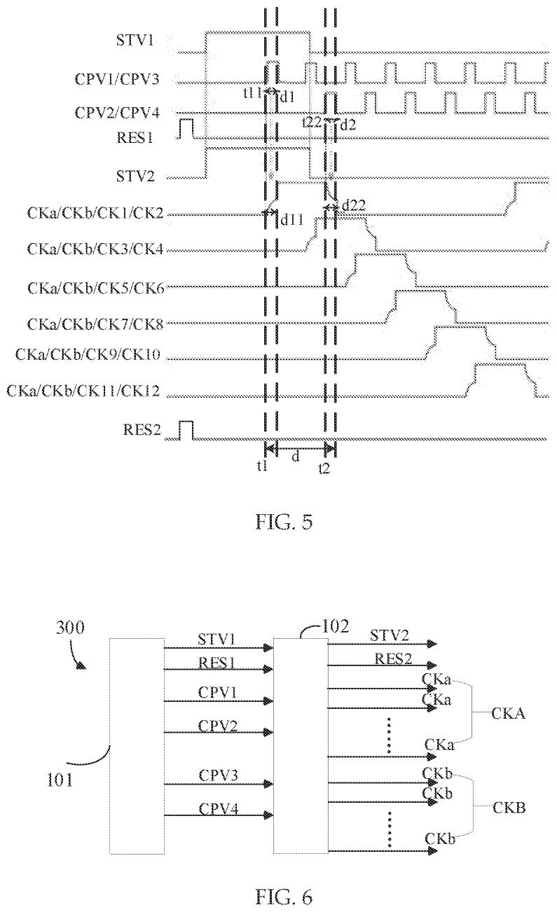

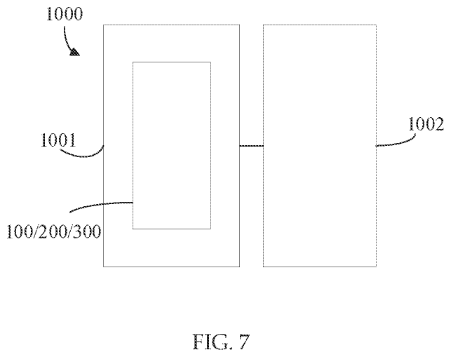

FIG. 6 is a schematic diagram illustrating a third structure of a driving circuit provided in an embodiment of the present application. The differences between the driving circuit 300 shown in FIG. 6 and the driving circuit 100 shown in FIG. 1 are that in the driving circuit 300 shown in FIG. 6, the timing controller 101 is further configured to output a third timing control signal CPV3 and a fourth timing control signal CPV4; the first voltage level converter 102 is configured to output a second clock signal set based on the third timing control signal CPV3 and the fourth timing control signal CPV4. The second clock signal set CKB includes a plurality of second clock signals CKb. It needs to be noted that the number of the second clock signals CKb can be set based on actual needs.

The only difference between the driving circuit 300 shown in FIG. 6 and the driving circuit 200 shown in FIG. 3 is that the driving circuit 200 shown in FIG. 3 is provided with the second voltage level converter 103, the second clock signal set CKB is outputted by using the second voltage level converter 103 while the second clock signal set CKB is outputted by using the first voltage level converter 102 in the driving circuit 300 shown in FIG. 6. Each of the signals in the driving circuit 300 shown in FIG. 6 may be referred to each of signals in the driving circuit 200 shown in FIG. 3 for more details, which are not repeated herein.

FIG. 7 is a schematic diagram showing the structure of a display device provided in an embodiment of the present application. The display device 1000 provided in the embodiment of the present application includes a control panel 1002 and a control panel 1001 connected to the display panel 1002. The control panel 1001 includes the afore-described driving circuit 100/200/300.

The driving circuit and the display device provided in the embodiments of the present application are described in detail above. The principle and implementation of the present application are described herein through specific examples. The description about the embodiments of the present application is merely provided to help understanding the method and core ideas of the present application. In addition, persons of ordinary skill in the art can make variations and modifications to the present application in terms of the specific implementations and application scopes according to the ideas of the present application. Therefore, the content of specification shall not be construed as a limit to the present application.

1. A driving circuit, comprising:
a timing controller, configured to output a first timing control signal and a second timing control signal;
a first voltage level converter, connected to the timing controller, configured to output a first clock signal set based on the first timing control signal and the second timing control signal;
wherein the first clock signal set comprises a plurality of first clock signals, the first voltage level converter determines a start time point of a rising edge of each of the first clock signals based on the first timing control signal, and the first voltage level converter determines the start time point of a falling edge of each of the first clock signals based on the second timing control signal.

2. The driving circuit of claim 1, wherein the start time point of a m-th rising edge of a n-th first clock signal corresponds to the start time point of a (n+(m−1)*k)-th rising edge of the first timing control signal, the start time point of a m-th falling edge of the n-th first clock signal corresponds to the start time point of a (n+(m−1)*k)-th rising edge of the second timing control signal, both n and m are integers greater than 0, and k is a number of the first clock signals.

3. The driving circuit of claim 1, wherein the first voltage level converter determines a pulse width of each of the first clock signals based on the start time point of the rising edge of the first timing control signal and the start time point of the falling edge of the second timing control signal.

4. The driving circuit of claim 3, wherein the pulse width of each of the first clock signals is equal to a difference between the start time point of a corresponding rising edge of the first timing control signal and the start time point of a corresponding falling edge of the second timing control signal.

5. The driving circuit of claim 1, wherein the first voltage level converter determines an edge cut-off width corresponding to the rising edge of the first clock signal based on a pulse width of the first timing control signal.

6. The driving circuit of claim 5, wherein the pulse width of the first timing control signal is equal to the edge cut-off width corresponding to the rising edge of the first clock signal.

7. The driving circuit of claim 1, wherein the first voltage level converter determines an edge cut-off width corresponding to the falling edge of the first clock signal based on a pulse width of the second timing control signal.

8. The driving circuit of claim 7, wherein the pulse width of the second timing control signal is equal to the edge cut-off width corresponding to the falling edge of the first clock signal.

9. The driving circuit of claim 1, wherein the timing controller is further configured to output a third timing control signal and a fourth timing control signal;
the driving circuit further comprises a second voltage level converter, which is connected to the timing controller and is configured to output a second clock signal set based on the third timing control signal and the fourth timing control signal;
the second clock signal set comprises a plurality of second clock signals, the second voltage level converter determines the start time point of the rising edge of each of the second clock signals based on the third timing control signal, and the second voltage level converter determines the start time point of the falling edge of each of the second clock signals based on the fourth timing control signal.

10. The driving circuit of claim 9, wherein the first timing control signal, the second timing control signal, the third timing control signal and the fourth timing control signal are signals having a same period and a predetermined phase difference.

11. The driving circuit of claim 9, wherein the first timing control signal and the third timing control signal are a same signal, and the second timing control signal and the fourth timing control signal are a same signal.

12. The driving circuit of claim 1, wherein the timing controller is further configured to output a third timing control signal and a fourth timing control signal;
the first voltage level converter is further configured to output a second clock signal set based on the third timing control signal and the fourth timing control signal;
the second clock signal set comprises a plurality of second clock signals, the first voltage level converter determines the start time point of the rising edge of each of the second clock signals based on the third timing control signal, and the second voltage level converter determines the start time point of the falling edge of each of the second clock signals based on the fourth timing control signal.

13. The driving circuit of claim 1, wherein the timing controller is further configured to output a start control signal and a reset control signal;
the first voltage level converter is further configured to output a start signal based on the start control signal; the first voltage level converter is further configured to output a reset signal based on the reset control signal.

14. The driving circuit of claim 1, wherein the start time point of the rising edge of the first clock signal is equal to the start time point of a corresponding rising edge of the first timing control signal, and the start time point of the falling edge of the first control signal is equal to the start time point of a corresponding rising edge of the second timing control signal.

15. A display device, comprising a display panel and a control panel connected to the display panel, the control panel comprising a driving circuit, which comprises:
a timing controller, configured to output a first timing control signal and a second timing control signal;
a first voltage level converter, connected to the timing controller, configured to output a first clock signal set based on the first timing control signal and the second timing control signal;
wherein the first clock signal set comprises a plurality of first clock signals, the first voltage level converter determines a start time point of a rising edge of each of the first clock signals based on the first timing control signal, and the first voltage level converter determines the start time point of a falling edge of each of the first clock signals based on the second timing control signal.

16. The display device of claim 15, wherein the start time point of a m-th rising edge of a n-th first clock signal corresponds to the start time point of a (n+(m−1)*k)-th rising edge of the first timing control signal, the start time point of a m-th falling edge of the n-th first clock signal corresponds to the start time point of a (n+(m−1)*k)-th rising edge of the second timing control signal, both n and m are integers greater than 0, and k is a number of the first clock signals.

17. The display device of claim 15, wherein the first voltage level converter determines a pulse width of each of the first clock signals based on the start time point of the rising edge of the first timing control signal and the start time point of the falling edge of the second timing control signal.

18. The display device of claim 15, wherein the first voltage level converter determines an edge cut-off width corresponding to the rising edge of the first clock signal based on a pulse width of the first timing control signal.

19. The display device of claim 15, wherein the first voltage level converter determines an edge cut-off width corresponding to the falling edge of the first clock signal based on a pulse width of the second timing control signal.

20. The display device of claim 15, wherein the timing controller is further configured to output a third timing control signal and a fourth timing control signal;
the driving circuit further comprises a second voltage level converter, which is connected to the timing controller and is configured to output a second clock signal set based on the third timing control signal and the fourth timing control signal;
the second clock signal set comprises a plurality of second clock signals, the second voltage level converter determines the start time point of the rising edge of each of the second clock signals based on the third timing control signal, and the second voltage level converter determines the start time point of the falling edge of each of the second clock signals based on the fourth timing control signal.
